(19) United States
(12) Patent Application Publication
(10) Pub. No.: US 2022/0004148 A1
(43) Pub. Date: Jan. 6, 2022

(54) APPARATUS AND METHOD OF REPRODUCTION OF A DIFFRACTIVE PATTERN

(71) Applicant: Grimaldi, Inc., Palm Harbor, FL (US)

(72) Inventor: Ilija Jergovic, Menlo Park, CA (US)

(21) Appl. No.: 16/920,912

(22) Filed: Jul. 6, 2020

(51) Int. Cl. G03H 1/26

(52) U.S. Cl. CPC G03H 1/268

(57) ABSTRACT

The present invention is an apparatus and method for display of a diffractive pattern. An array of optical elements called phasels are operative to transmit light of different phase shifts to create a diffractive pattern. Individual optical elements may create fixed phase shifts, or the phase shift may be variable. A method is demonstrated for encoding a diffractive pattern onto an array of phasels for display of a three dimensional image.

### BACKGROUND OF THE INVENTION

The present application relates to recognition, capture, and reproduction of three-dimensional wavefronts for three-dimensional (3D) image reproduction and 3D printing, and also for Lidar, Radar and sound reproduction.

Modern consumer electronics companies continue to pursue various 3D display technology implementations. Current 3D viewing systems rely on stereoscopic displays, vectored light fields, or multiple focal planes to create the illusion of depth. These existing systems introduce significant shortcomings. First, the quality of image reproduction with some 3D technologies, such as stereoscopic 3D display, is dependent on the viewer being positioned in the exact same orientation as the recording apparatus. Deviation from this exact positioning results in loss of the stereo (or 3D) effect, a condition known as diplopia. Something as common as lying askance on a couch will destroy the 3D effect. Also, many of these 3D viewing solutions require the user to wear some type of head-mounted glasses. These glasses are not compatible between different displays—some require passive, or polarized, glasses, and others use an active, shutter-based solution. Additionally, users frequently complain of eye strain when viewing 3D images. More serious conditions, such as “binocular dysphoria”, can also result from long-term exposure to these technologies. These and other shortcomings have led to the current market environment, where despite significant time and investment, no 3D display technology has succeeded in the commercial marketplace.

Reproduction of holographic images has emerged as a promising 3D display technology which can address many of the shortcomings in these existing technologies. A hologram records a diffractive pattern which includes all the characteristics of the light waves for a particular image, including phase, amplitude and wavelength. For the viewer, there is no difference between viewing the original image and viewing the hologram. The first holograms were produced by recording diffractive patterns on physical photographic film and reproducing the image by illuminating the developed film with the same coherent laser light used to record the image on the film. Today, there is work ongoing into reproducing holograms by using computer-generated holographic patterns displayed on active panels using a spatial light modulator.

Despite the promise of holographic displays, these solutions are currently limited by the computational complexity required to generate the image information and the display technology required. Generating even a small sized image can require unrealistic computing resources. There is a need for new technologies which can reduce the computational complexity required for holographic image representation and enable 3D holographic image reproduction on existing display panel technologies.

### BRIEF SUMMARY OF THE INVENTION

In one embodiment, presented by way of example and not limitation, an optical component, which we define as a sub-phasel, includes a magnitude modulator for selectively transmitting incoming light, and an optional phase-altering element for modifying the phase of light passing through the sub-phasel.

In one embodiment, presented by way of example and not limitation, multiple sub-phasels are combined into a phasel, which is capable to selectively transmit light with different phase delays.

In one embodiment, presented by way of example and not limitation, an array of phasels is capable to display a complex diffractive pattern by selectively enabling combinations of sub-phasels to transmit light with different phase delays. A viewer positioned in front of the display is able to view the entire wavefront reproduced by the phasels which produces a true 3D image with full parallax.

### BRIEF DESCRIPTION OF THE DRAWINGS

FIG. 1 is an embodiment of a phasel.

FIG. 2 is an embodiment of a single sub-phasel element.

FIG. 3 is a demonstration of the phase-altering effects of coherent light passing through media of different refractive indices.

FIG. 4 is another embodiment of a phasel.

FIG. 5 is a demonstration of multiple sub-phasels generating a diffractive pattern.

FIG. 6 is a top-view of a rectilinear grid of multiple sub-phasels.

FIG. 7 is a side-view perspective of the rectilinear grid of multiple sub-phasels.

FIG. 8 is a top-view of a hexagonal tiled array of multiple sub-phasels.

FIG. 9 is a flowchart of a method for use of the present invention for display of a diffractive pattern.

### DETAILED DESCRIPTION

The following description includes specific details to provide an understanding of the present invention. Embodiments of the present invention described in the following specification may be incorporated into different optical components not disclosed in the following specification. Structures and elements shown in the drawings are exemplary embodiments of the present invention and are not to be used to limit broader teachings of the present invention.

It is understood through the text of this disclosure that where elements are described as separate functional units, those skilled in the art will recognize that various elements or portions thereof may be integrated together. Where elements are described in the following disclosure as integrated together into a combined element, those skilled in the art will recognize that individual elements of the combination may be utilized as separate elements.

This specification includes reference to “an embodiment of the present invention” or “one embodiment of the present invention”. This language is intended to refer to the particular elements and structures of the embodiment being referenced in that portion of the specification. Where references are made to “an embodiment of the present invention” or “one embodiment of the present invention” in other portions of the specification, those similarly refer to those particular elements and structures of the embodiment being referenced in that portion of the specification. Embodiments discussed in different portions of the specification may or may not refer to the same embodiment of the present invention.

The use of specific terminology in the specification is used for best describing the present invention and shall not be construed as limiting. The terms “include”, “including”, “comprise” and “comprising” shall be understood to be open terminology and not limiting the listed items.

Existing display technologies, including liquid-crystal display panels, may use an optical element called a pixel to reproduce complex images. The term pixel is derived from a shortening of the words “picture element”. Pixels may be arranged in a large array for reproducing images. In a monochromatic image, each pixel may reproduce light of varying intensities to create an image. In a color image, each pixel may reproduce red, green or blue light in varying intensities. Using this technique, an array of many pixels is capable to reproduce a complex image.

In the present invention, we define an optical element called a phasel, which is a shortening of the words “phase element”. Where a pixel uses varying intensities of light to reproduce an image, the phasel uses varying phases of light to reproduce an image or diffractive pattern.

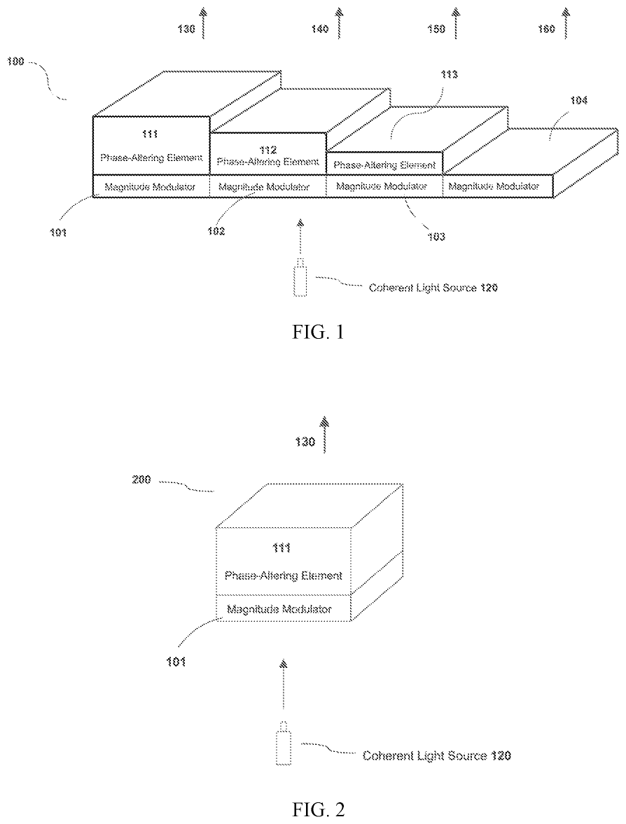

FIG. 1 shows one embodiment of a phasel 100. Each phasel is comprised of multiple sub-phasels. Each sub-phasel is a vertical stack comprising a magnitude modulator, and, optionally, a phase-altering element. In the embodiment shown in FIG. 1, the first sub-phasel is comprised of a magnitude modulator 101 and a phase-altering element 111. A second sub-phasel is comprised of a magnitude modulator 102 and a phase-altering element 112. A third sub-phasel is comprised of a magnitude modulator 103 and a phase-altering element 113. A fourth sub-phasel is comprised of a magnitude modulator 104. The embodiment of FIG. 1 includes four distinct sub-phasels, but other embodiments may contain more sub-phasels or fewer sub-phasels than the number of sub-phasels shown in the embodiment of FIG. 1.

FIG. 2 shows a more detailed view of a single sub-phasel 200. Coherent light source 120 illuminates the sub-phasel 200. In one embodiment, coherent light source 120 may be a laser light source. In other embodiments, coherent light source 120 may be a laser diode. In other embodiments, the coherent light source 120 may be provided via a fiber optic connection to a common source. Other embodiments may include coherent light sources not explicitly enumerated in this description. Coherent light enters the sub-phasel at magnitude modulator 101. Magnitude modulator 101 is selectively enabled to pass or reject light through the sub-phasel 200. In one embodiment, magnitude modulator 101 may be a liquid crystal. In other embodiments, magnitude modulator 101 may be a digital micromirror device, LED, or a spatial light modulator. Phase-altering element 111 introduces a phase shift in the light from coherent light source 120. In one embodiment, phase-altering element 111 may be a solid glass material which modifies incoming light by a fixed phase delay. In another embodiment, the phase altering element 111 may be incorporated as part of the cover glass in a display. In other embodiments, phase-altering element 111 may be a liquid-based electrowetting lens, which introduces a variable delay based on an applied voltage. In other embodiments, phase-altering element 111 may be a glass surface attached to a piezoelectric element. The piezoelectric stress on the glass modifies the refractive index of the glass and produces varying phase delays depending on the piezoelectric stress. Other embodiments of the phase-altering element 111 may utilize technologies not specifically enumerated in this description.

Light exiting the sub-phasel 200 in the direction of arrow 130 is a phase-altered version of the light from coherent light source 120. All sub-phasels in FIG. 1 are of a similar structure to sub-phasel 200 shown in FIG. 2. The embodiment of FIG. 2 shows a sub-phasel as a rectangular shaped element, but one skilled in the art will understand that other embodiments of a sub-phasel can have other shapes. In another embodiment, the sub-phasel may be a cylindrical shape, and in another embodiment the sub-phasel may be a hexagonal shape. In other embodiments, the sub-phasel may be another shape not specifically enumerated in this description.

With reference to the complete phasel of FIG. 1, coherent light source 120 illuminates the entire phasel 100. Light exits the first sub-phasel in the direction indicated by arrow 130. Light exits the second sub-phasel in the direction indicated by arrow 140. Light exits the third sub-phasel in the direction indicated by arrow 150. Light exits the fourth sub-phasel in the direction indicated by arrow 160.

The combination of different phase-altering elements 111, 112 and 113 produces light with varying phase shifts at the output of each sub-phasel. The embodiment shown in FIG. 1 includes a specific configuration of magnitude modulators and phase-altering elements. One skilled in the art will understand that other embodiments of a phasel may include sub-phasels that all include both a magnitude modulator and a phase-altering element. Other embodiments may include more than one sub-phasel that includes only a magnitude modulator.

The embodiment of FIG. 1 shows the coherent light source and the magnitude modulator as two separate elements, but one skilled in the art will appreciate that in other embodiments of the present invention, these two elements may be combined into a single element.

The passage of light through different physical media is governed by the refractive index of the medium, denoted as n in the literature. This same terminology will be used throughout this specification. It is known that the wavelength of light through a medium is modified as follows: λₙ=λ/n, where λₙ is the wavelength of light in a medium with refractive index n, and λ, is the wavelength of the light in a vacuum. Using this relationship, we can compute the phase difference between light passing through different media. This will be demonstrated with a brief example.

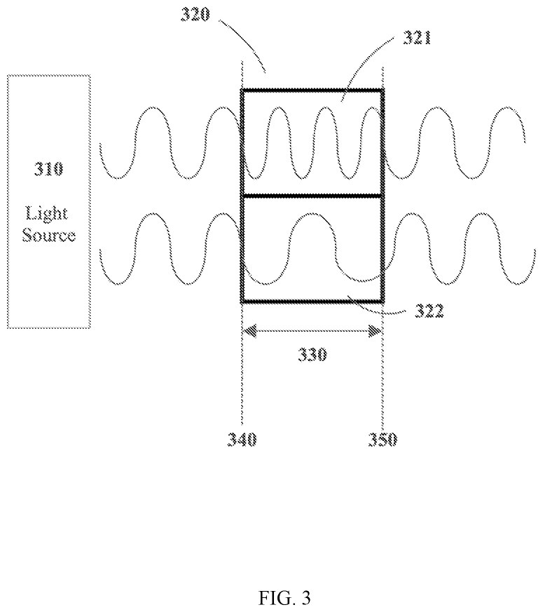

Referring to FIG. 3, a light source 310 emits coherent light of wavelength λ. This light passes through a phase-altering optical element 320 with length L 330. The phase-altering optical element 320 is separated into two sections, a top section 321 with refractive index n₁, and a bottom section 322 with refractive index nz. As light source 310 generates coherent light, the emitted light is in phase when it reaches the left edge of the phase-altering element 320, shown as the dashed line 340. Once the light is travelling through the phase-altering element, the wavelength of the light changes based on the earlier equation:

$${λ}_{n} = \frac{λ}{n} ,$$

where λₙ is the wavelength of light in a medium with refractive index n, and λ is the wavelength of the light in a vacuum. In order to compute the phase of the light when exiting the phase-altering element, we need to compute the number of wavelengths of light in the length of the phase-altering element, represented as length L 330. We will use the notation of φ_{A} to represent the phase of light entering the phase altering element at location 340. The equation for the phase at the exit of the top section of the phase altering element 321, φ_{B}, is given by

$${φ}_{B} = {φ}_{A} + 2 π ( \frac{{n}_{1}}{λ} ) * L .$$

In the example shown in FIG. 3, n₁ is greater than the refractive index of a vacuum, such that the wavelength of the light is shorter while travelling through the phase-altering element. Similarly, the equation for the phase at the exit of bottom section of the phase altering element 322, φ_{C}, is given by

$${φ}_{C} = {φ}_{A} + 2 π ( \frac{{n}_{2}}{λ} ) * L .$$

In the example shown in FIG. 3, n₂ is less than the refractive index of a vacuum, such that the wavelength of the light is longer while travelling through the phase-altering element. It is shown that when exiting the phase altering element along the line 350, the phase of the two light waves is different because of the difference in refractive indices of the top section 321 and bottom section 322 of the phase-altering element.

The previous description is given only as a mathematical example for illustrative purposes. One skilled in the art will appreciate that while this illustrative example is shown with a phase-altering element of two sections, embodiments may include any plurality of sections. Other embodiments may include a phase altering element with one section. Other embodiments may utilize optical media with different refractive indices of the top and bottom section of the phase-altering elements than what is shown. All sections may have refractive indices higher than the refractive index of a vacuum, or all sections may have refractive indices lower than the refractive index of a vacuum, or there may be sections with any combination of refractive indices both higher and lower than the refractive index of a vacuum. The choice of refractive indices in this example does not imply the use of any specific materials in the present invention.

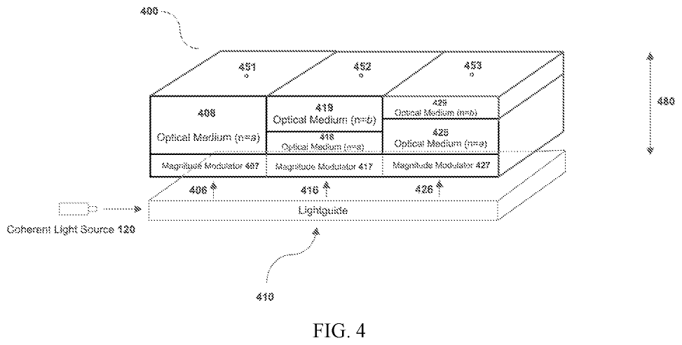

FIG. 4 shows another embodiment of a phasel 400. In this embodiment, light is generated at coherent light source 120. Light from coherent light source 120 is input to lightguide 410 which redirects the light to each sub-phasel. In FIG. 4, the sub-phasel comprised of magnitude modulator 407 and optical medium 408 shall be termed the first sub-phasel. The sub-phasel comprised of magnitude modulator 417, optical medium 418, and optical medium 419 shall be termed the second sub-phasel. The sub-phasel comprised of magnitude modulator 427, optical medium 428, and optical medium 429 shall be termed the third sub-phasel. The lightguide 410 redirects light to the first sub-phasel as shown by arrow 406. The lightguide 410 similarly directs light to the other two sub-phasels as indicated by arrow 416 and arrow 426. The number of sub-phasels shown is for illustrative purposes only, and one skilled in the art will appreciate that other embodiments of the present invention may be comprised of more sub-phasels or fewer sub-phasels.

During operation of the apparatus of FIG. 4, light enters the first sub-phasel via the path marked by arrow 406. Magnitude modulator 407 is controllable to selectively pass or block the incoming light. When light is passed through the magnitude modulator 407, it then passes through optical medium 408. Optical medium 408 has a refractive index denoted as a. In embodiments of the present invention, optical medium 408 may be comprised of glass, a polymeric material, a glass coated with a film, or another optical material. The phase of the light passing through optical medium 408 is modified by the refractive index of optical medium 408. Light exits the first sub-phasel at the location marked 451. Location 451 is merely intended as a representation of the exit of light from the first sub-phasel, it does not necessarily represent a physical hole or other disturbance to the physical material of the sub-phasel. In a similar manner, light enters the second sub-phasel via the path marked by arrow 416. The magnitude modulator 417 is controllable to selectively pass or block the incoming light. When light is passed through the magnitude modulator 417, it then passes through optical medium 418. Optical medium 418 has a refractive index denoted as a. This refractive index of optical medium 418 is the same as the refractive index of optical medium 408. Light passes from optical medium 418 to a second optical medium 419. Optical medium 419 has a refractive index denoted as b, which is different from the refractive index of optical medium 418. In embodiments of the present invention, optical medium 418 may be comprised of glass, a polymeric material, a glass coated with a film, or another optical material. In embodiments of the present invention, optical medium 419 may be comprised of glass, a polymeric material, a glass coated with a film, or another optical material. The phase of the light passing through optical medium 418 is modified by the refractive index of optical medium 418 and then passes through optical medium 419 where the phase of the light is further modified by the refractive index of optical medium 419. Light exits the second sub-phasel at the location marked 452. Location 452 is merely intended as a representation of the exit of light from the second sub-phasel, it does not necessarily represent a physical hole or other disturbance to the physical material of the sub-phasel. In a similar manner, light enters the third sub-phasel via the path marked by arrow 426. The magnitude modulator 427 is controllable to selectively pass or block the incoming light. When light is passed through the magnitude modulator 427, it then passes through optical medium 428. Optical medium 428 has a refractive index denoted as a. This refractive index of optical medium 428 is the same as the refractive index as the refractive index of optical medium 408 and of optical medium 418. Light passes from optical medium 428 to a second optical medium 429. Optical medium 429 has a refractive index denoted as b, which is different from the refractive index of optical medium 418 and the same as the refractive index of optical medium 419. In embodiments of the present invention, optical medium 428 may be comprised of glass, a polymeric material, a glass coated with a film, or another optical material. In embodiments of the present invention, optical medium 429 may be comprised of glass, a polymeric material, a glass coated with a film, or another optical material. The phase of the light passing through optical medium 428 is modified by the refractive index of optical medium 428 and then passes through optical medium 429 where the phase of the light is further modified by the refractive index of optical medium 429. Light exits the third sub-phasel at the location marked 453. Location 453 is merely intended as a representation of the exit of light from the third sub-phasel, it does not necessarily represent a physical hole or other disturbance to the physical material of the sub-phasel.

The embodiment of FIG. 4 is shown with optical media of fixed refractive indices, indicated by n=a for optical media 408, 418 and 428, and indicated by n=b for optical media 419 and 429. Other embodiments of the apparatus of FIG. 4 may comprise optical media with different refractive indices.

Other embodiments of the apparatus of FIG. 4 may use optical media with a variable refractive index. In one embodiment, the optical media may be a liquid-based electrowetting lens in which an applied voltage can introduce a variable refractive index. In other embodiments, said optical media may be a glass surface attached to a piezoelectric element. The piezoelectric stress on the glass modifies the refractive index of the glass and produces varying phase delays depending on the piezoelectric stress.

Other embodiments of the apparatus of FIG. 4 may comprise optical media with different lengths, as measured in the direction of line 480. Optical media with longer lengths may enable larger phase shifts. Utilizing the apparatus of FIG. 4, one can construct sub-phasels with any phase shift by varying the refractive index of the optical media and the length of the optical media measured along the line 480. It is not necessary to use many different materials with exact refractive indices to produce a desired phase shift. By selecting only a small number of different optical media, the design of the phasel is greatly simplified, and one skilled in the art may construct a phasel composed of sub-phasels with any combination of phase shifts by varying the length of only a small number of actual optical media.

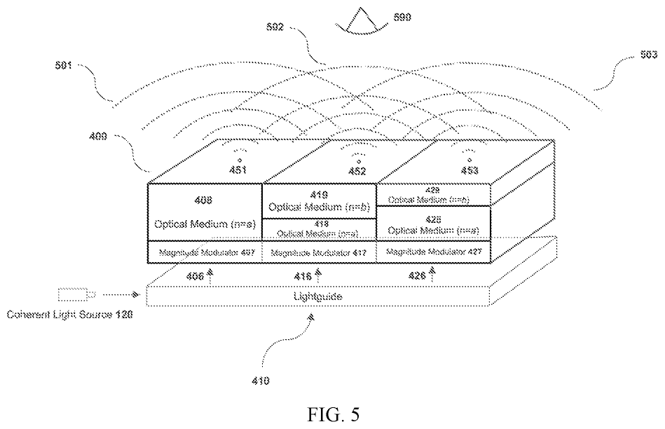

FIG. 5 is a representation of the phasel of FIG. 4, further showing the behavior of light waves passing through the phasel and generating a diffractive pattern. In FIG. 5, the sub-phasel comprised of magnitude modulator 407 and optical medium 408 shall be termed the first sub-phasel. The sub-phasel comprised of magnitude modulator 417, optical medium 418, and optical medium 419 shall be termed the second sub-phasel. The sub-phasel comprised of magnitude modulator 427, optical medium 428, and optical medium 429 shall be termed the third sub-phasel. Light passes from coherent light source 120 to lightguide 410 in the manner described previously. Light enters the first sub-phasel in the direction of arrow 406, and exits the first sub-phasel at the location 451. This location is intended merely to represent the location where light exits the sub-phasel to aid in this description. Location 451 is not necessarily indicative of a physical opening in the material. Light exiting at location 451 can be represented as a point source, with light waves radiating outward from the exit point 451. The radiating wavefront is represented by the concentric dashed lines 501. Light enters the second sub-phasel in the direction of arrow 416, and exits the second sub-phasel at the location 452. This location is intended merely to represent the location where light exits the sub-phasel to aid in this description. Location 452 is not necessarily indicative of a physical opening in the material. Light exiting at location 452 can be represented as a point source, with light waves radiating outward from the exit point 452. The radiating waves are represented by the concentric dashed lines 502. Light enters the third sub-phasel in the direction of arrow 426, and exits the third sub-phasel at the location 453. This location is intended merely to represent the location where light exits the sub-phasel to aid in this description. Location 453 is not necessarily indicative of a physical opening in the material. Light exiting at location 453 can be represented as a point source, with light waves radiating outward from the exit point 453. The radiating wavefront is represented by the concentric dashed lines 503. A viewer positioned at location 590 will see the complex diffraction pattern created by the interaction of all the light waves exiting the phasel at locations 451, 452 and 453. By varying the optical media to create different phase shifts in the light, one can produce different diffraction patterns representing different images.

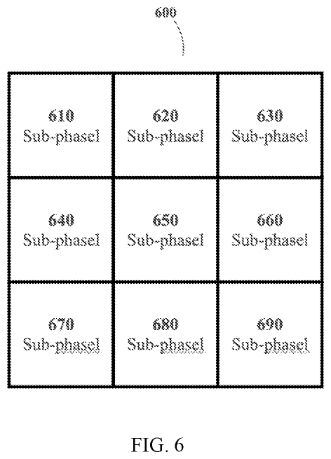

In order to create a large image, multiple sub-phasels must be combined into a large array. In FIG. 5, the sub-phasels are arranged in only one dimension to create a 3×1 array. FIG. 6 shows a top view of another embodiment of a grid of multiple sub-phasels to form one phasel 600. In this embodiment, there are 9 separate sub-phasels, labelled 610, 620, 630, 640, 650, 660, 670, 680, and 690, arranged in a 3×3 grid. Each sub-phasel may create a different phase delay from all other sub-phasels, or some sub-phasels may create the same phase delays. The embodiment of FIG. 6 is shown with 9 separate sub-phasels, but other embodiments may contain more or fewer sub-phasels, depending upon the physical size of the sub-phasel and the desired spatial resolution of the image.

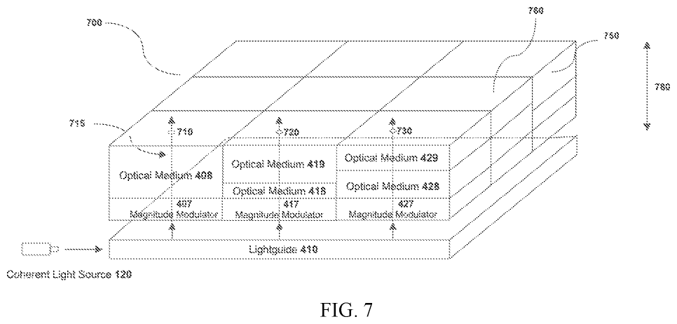

FIG. 7 shows a side view image of a phasel 700 which combines the grid of nine sub-phasels shown in FIG. 6 with the detailed cross-section of the phasel 400 shown in FIG. 4. In one embodiment, coherent light source 120 generates coherent light. Lightguide 410 directs this light from the coherent light source 120 to each of the individual sub-phasels. Light impacting magnitude modulator 407 is selectively transmitted or blocked by magnitude modulator 407. Light that is transmitted through magnitude modulator 407 travels through the sub-phasel via the path marked by arrow 715, exiting the subphasel at location 710. The phase of light passing through optical medium 408 is modified by the refractive index of optical medium 408. In a similar manner, lightguide 410 directs light from coherent light source 120 to magnitude modulator 417. Magnitude modulator 417 selectively transmits or blocks light from coherent light source 120. If magnitude modulator 417 transmits light, that light passes through optical medium 418 and optical medium 419. The refractive indices of optical medium 418 and optical medium 419 modify the phase of the light passing through each optical media. In this manner, light exiting optical medium 408 at location 710 may have a phase difference from light exiting optical medium 419 at location 720. In a similar manner, lightguide 410 directs light from coherent light source 120 to magnitude modulator 427. Magnitude modulator 427 selectively transmits or blocks light from coherent light source 120. If magnitude modulator 427 transmits light, that light passes through optical medium 428 and optical medium 429. The refractive indices of optical medium 428 and optical medium 429 modify the phase of the light passing through each optical medium. In this manner, light exiting optical medium 408 at location 710 may have a phase difference from light exiting optical medium 419 at location 720, which may have a phase difference from light exiting optical medium 429 at location 730. Light passing through the other six sub-phasels is modified in a similar manner. The dimensions of the optical media in phasel 700 may be different for different sub-phasels. In one embodiment, the dimensions of optical medium 760 are different from optical medium 750. This difference will create a difference between the phase shift of light passing through optical medium 760 and light passing through optical medium 750.

In other embodiments of FIG. 7, coherent light source 120 includes multiple sources, each capable of transmitting a different wavelength of light. In one embodiment, coherent light source 120 includes red, green and blue light sources. By time-multiplexing between the different colors of light, a color image can be reproduced. In another embodiment, the light sources of different wavelengths may be integrated into each sub-phasel, whereby each sub-phasel includes multiple light sources capable to generate light of different wavelengths, and multiple magnitude modulators capable to selectively transmit the light from said multiple sources.

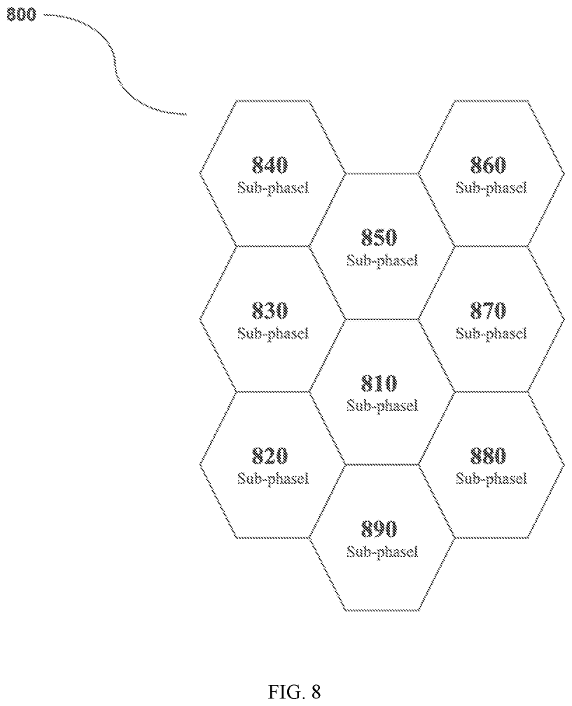

FIG. 8 is a top view of another embodiment of a phasel 800. FIG. 8 is a similar top view perspective as FIG. 6, but represents another embodiment of a phasel. In this embodiment, individual phasels are arranged in a hexagonal grid. This embodiment of a phasel is shown with nine individual sub-phasels, but one skilled in the art will understand that other embodiments of a hexagonal grid may contain more or fewer sub-phasels than the number of sub-phasels shown in FIG. 8. In a hexagonal grid, each sub-phasel is the same distance from each of its nearest neighbors, which simplifies the encoding of information required for display of the image. For example, the distance from the center of sub-phasel 810 is the same to each of its neighbors, sub-phasels 820, 830, 850, 870, 880, and 890. In contrast, in the rectilinear grid of FIG. 5, only the four direct neighbors of sub-phasel 650, sub-phasels 620, 640, 660 and 680, are all the same distance from center sub-phasel 650. We will call this distance d. The four diagonal neighbors, specifically sub-phasels 610, 630, 670 and 690, are a distance d*\sqrt{2} from the center sub-phasel 650. Given that the image reproduction will differ depending on the arrangement of the sub-phasels, a hexagonal grid with a more consistent arrangement of sub-phasels may be preferred.

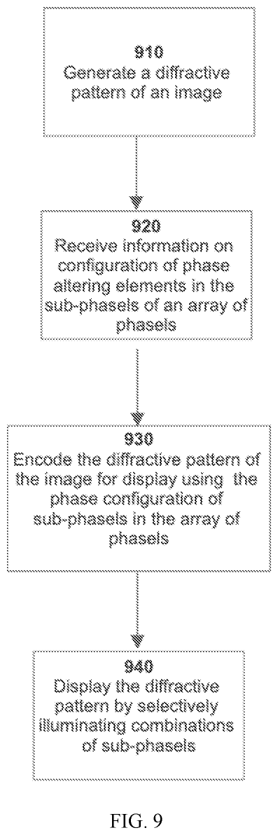

In one embodiment, an array of multiple phasels can be arranged to function as a spatial light modulator capable to reproduce a complex image wavefront by reproducing light of different phases at different locations. The spatial light modulator selectively enables sub-phasels within each phasel to produce an image wavefront. FIG. 9 shows a flowchart of a method for display of a diffractive pattern using the apparatus of the present invention. Any of the embodiments of phasel arrays described in this disclosure are capable to reproduce a complex wavefront utilizing this method. The first step 910 is to generate a diffraction pattern of the desired 3D image. The diffraction pattern of the image can be calculated using known techniques from computational holography. As one example, the diffractive pattern can be computed based on a superposition of all image points in the desired image. Each location in the image is treated as a point source of light, and the diffractive pattern for the entire image is the superposition of the diffractive field emitted from all points in the 3D image. The diffractive pattern may also be generated using a reference beam of coherent light to illuminate the image. In other embodiments of the present invention, other techniques may be used to generate the diffraction pattern. The second step 920 is receiving information on the phase configuration and arrangement of the phase-altering elements in the sub-phasels in an array of phasels. An embodiment of the present invention may include phasels with a 3×3 hexagonal array of sub-phasels, each sub-phasel configured to shift the phase of incoming light by increasing multiples of

$$\frac{π}{9} ,$$

from 0 to

$$\frac{{8}^{*} π}{9} ,$$

inclusive. Other embodiments may include phasels with a 2×2 array of sub-phasels, each sub-phasel configured to shift the phase of incoming light by

$$0 , \frac{π}{4} , \frac{π}{2} and \frac{{3}^{*} π}{4} .$$

Other embodiments may include a different number of sub-phasels per phasel, and different phase delays than those specifically mentioned in this disclosure. In one embodiment, the phase shifts of each sub-phasel may be unit delays between 0 and 2π. In other embodiments, the phase delays of each sub-phasel may be irregular increments of delay. In other embodiments, multiple sub-phasels may implement identical phase delay values. In other embodiments, all sub-phasels may implement a different numerical phase delay. The phase delay of each sub-phasel may be a calculation based on the size and composition of optical media in the sub-phasel, or it may be a measured phase delay of each sub-phasel. In step 930, the diffractive pattern calculated in step 910 is encoded for display on a display apparatus using the available phase delays received in step 920. In one embodiment, the diffractive pattern is encoded to drive liquid crystal elements. In other embodiments, the diffractive pattern is encoded to drive a digital micromirror device. The final step 940 is to display the diffractive pattern on the display apparatus by driving the encoded diffractive pattern onto the display apparatus. In one embodiment of the present invention, the display apparatus may be a liquid-crystal display panel, with a backlight providing the coherent light source, and selective liquid-crystal elements activated to generate the desired phase delays to reproduce the image wavefront. In another embodiment, the display apparatus may be a digital micro-mirror display panel. In embodiments utilizing a reference beam of coherent light for generation of the diffraction pattern, the display of the diffraction pattern may also utilize a reference beam of coherent light as an element of the reproduction of the image. The disclosed method may be used in conjunction with phasel arrays disclosed in this description, or with other apparatus not specifically disclosed in this description.

We claim:

1. An apparatus for a phasel, comprising:
an array of sub-phasels, each sub-phasel comprising:
an element operative to control transmission of light through the sub-phasel,
an optional phase-altering element which is operative to modify the phase of light.

2. The apparatus of claim 1, wherein said phase-altering element alters the phase of light by a fixed phase angle.

3. The apparatus of claim 2, wherein said phase-altering element is incorporated into a cover glass structure of a display panel.

4. The apparatus of claim 1, wherein said phase-altering element alters the phase of light by a variable phase angle.

5. The apparatus of claim 4, wherein said phase-altering element is an electrowetting lens.

6. The apparatus of claim 4, wherein said phase-altering element is a piezoelectric element.

7. The apparatus of claim 1, wherein said sub-phasels are arranged in a rectilinear grid.

8. The apparatus of claim 1, wherein said sub-phasels are arranged in a tiled hexagonal array.

9. An apparatus for a spatial light modulator comprising:
an array of phasels,
a light source operative to illuminate said array of phasels,
a controller coupled to each phasel, operative to control the transmission of light through the sub-phasels of each phasel.

10. The apparatus of claim 9, wherein said light source is a backlight which modifies the phase of light to individual phasels.

11. The apparatus of claim 9, wherein said array of phasels is further comprised of multiple sub-arrays, coordinated to reproduce a single image.

12. The apparatus of claim 9, wherein said light source is a single coherent light source supplied to all sub-arrays via a fiber optic channel.

13. The apparatus of claim 9, wherein said light source further comprises a light source capable to transmit light of different wavelengths.

14. A method of display of a diffractive pattern, comprising:
generating a diffractive pattern of an image,
receiving information on the phase configuration of the phase-altering elements of the sub-phasels in an array of phasels,
encoding said diffractive pattern of said image for display using said phase configuration of said sub-phasels in said array of phasels,
displaying said diffractive pattern by selectively illuminating combinations of sub-phasels.

15. The method of claim 14, wherein the receiving information further comprises storing the phase configuration information in non-transitory storage media within the display.

16. The method of claim 14, wherein the receiving information further comprises receiving the actual phase alteration in each sub-phasel.

17. The method of claim 14, wherein displaying said diffraction pattern further comprises illuminating the display with a reference beam of coherent light.
